(19) United States
(12) Patent Application Publication
(10) Pub. No.: US 2020/0271470 A1
(43) Pub. Date: Aug. 27, 2020

(54) VEHICLE PATH IDENTIFICATION

(71) Applicant: Ford Global Technologies, LLC, Dearborn, MI (US)

(72) Inventors: David A. Symanow, Plymouth, MI (US); Ray Siciak, Ann Arbor, MI (US)

(73) Assignee: Ford Global Technologies, LLC, Dearborn, MI (US)

(21) Appl. No.: 16/284,026

(22) Filed: Feb. 25, 2019

(51) Int. Cl. G01C 21/34; G01C 21/36; B60W 20/12; B60W 20/13

(52) U.S. Cl. CPC G01C 21/3469; B60W 20/13; B60W 20/12; G01C 21/3691

(57) ABSTRACT

A system includes a computer including a processor and a memory. The processor is programmed to select a route for a vehicle based on an expected vehicle energy usage along the route based on an expected condition along the route in an environment above a road. The processor is further programmed to operate the vehicle along the route.

### BACKGROUND

A driving range for vehicles such as Hybrid Electric Vehicles (HEV) and Battery Electric Vehicles (BEV) can be limited by an amount of energy stored in a vehicle electrical energy storage system. External conditions may vary resulting in uncertainty in determining whether a vehicle can complete a mission. The need to disrupt a mission to recharge the vehicle can result in passenger dissatisfaction and increased down time for the vehicle.

### BRIEF DESCRIPTION OF THE DRAWINGS

FIG. 1 is a diagram illustrating an example system for vehicle mission energy planning.

FIG. 2 is a flow diagram of an example process for determining and/or adjusting a vehicle route based on expected vehicle energy usage.

FIG. 3 is flow diagram of an example process for estimating expected vehicle energy usage for a mission.

FIG. 4 is a graph of example sunrise and sunset data at a location for a year.

FIG. 5 is a graph of example sunrise and sunset data at a location for a day.

FIG. 6 is a graph illustrating example vehicle time-of-day related energy consumption.

FIG. 7 is a graph illustrating example vehicle energy consumption for cabin heating and cooling.

FIG. 8 is a graph illustrating example vehicle energy consumption for sensor heating and cooling.

FIG. 9 is a graph illustrating example vehicle energy consumption to mitigate precipitation effects on sensors.

### DETAILED DESCRIPTION

### Introduction

Disclosed herein is a system including a processor and a memory. The memory stores instructions executable by the processor to select a route for a vehicle based on an expected vehicle energy usage along the route based on an expected condition along the route in an environment above a road and operate the vehicle along the route.

The expected condition may be an expected weather condition.

The expected weather condition may include at least one selected from the group of ambient temperature, precipitation and fog.

The instructions may include further instructions to estimate the expected vehicle energy usage according to the expected condition by accounting for an expected energy usage for sensor maintenance along the route under the expected condition.

The expected energy usage for sensor maintenance may include an expected energy usage to maintain a temperature of a sensor within a specified range.

The expected energy usage for sensor maintenance may include an expected energy usage to clean a sensor.

The instructions may include further instructions to estimate the expected vehicle energy usage according to the expected condition based on an expected energy usage to maintain a temperature of an electronic control module within a specified range.

The instructions may include further instructions to estimate the expected vehicle energy usage based on an expected energy usage to maintain a temperature of a high-voltage traction battery within a specified range.

The instructions may include further instructions to update the expected condition while operating the vehicle along the route, adjust an operating parameter of the vehicle based on the updated expected condition; and update the expected energy usage based on adjusting the operation of the vehicle.

The instructions to adjust an operating parameter of the vehicle may include instructions to adjust a speed of the vehicle.

The instructions to select the route may include instructions to take into account an availability of sensor cleaning fluid.

The expected vehicle energy usage is an expected energy usage of the high-voltage traction battery.

Further disclosed herein is a method including selecting a route for a vehicle based on an expected vehicle energy usage along the route based on an expected condition along the route in an environment above a road; and operating the vehicle along the route.

The expected condition may be an expected weather condition.

The method may further include estimating the expected vehicle energy usage according to the expected condition by accounting for an expected energy usage for sensor maintenance along the route under the expected condition.

The expected energy usage for sensor maintenance includes at least one selected from a group of an expected energy usage to maintain a temperature of a sensor within a specified range and an expected energy usage to clean a sensor.

The method may further include estimating the expected vehicle energy usage according to the expected condition based on at least one selected from a group of an expected energy usage to maintain a temperature of an electronic control module within a specified range and an expected energy usage to maintain a temperature of a high-voltage traction battery within a specified range.

The method may further include updating the expected condition while operating the vehicle along the route, adjusting an operating parameter of the vehicle based on the updated expected condition; and updating the expected energy usage based on adjusting the operation of the vehicle.

Selecting the route may include taking into account an availability of sensor cleaning fluid.

The expected vehicle energy usage may be an expected energy usage of the high-voltage traction battery.

Further disclosed herein is a computing device programmed to execute any of the above method steps.

Yet further disclosed herein is a computer program product, including a computer readable medium storing instructions executable by a computer processor, to execute any of the above method steps.

Exemplary System Elements

A system to estimate an expected vehicle energy usage for a mission and adjust a route of the mission and/or operating parameters of the vehicle during the mission can reduce the likelihood of a mission disruption and vehicle downtime associated with the disruption, e.g., stranding a vehicle in the middle of a mission due to depleted battery charge and/or running out of fuel.

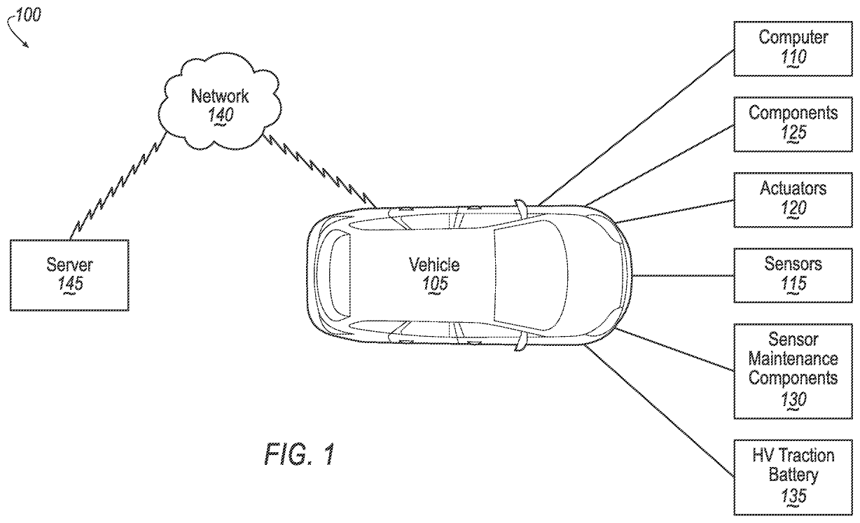

FIG. 1 is a block diagram of an example system 100, for managing energy usage for a mission for a vehicle 105. A mission is defined herein as a trip, i.e., one or more movements, executed by the vehicle 105 to perform one or more tasks, e.g., to navigate a specified route from an origin to a destination. The tasks are operations that the vehicle 105 is to perform during the mission and can include driving from a first parking location at a beginning of the mission to locations to pick-up passengers and/or cargo, delivering the passengers and/or cargo to target destinations, driving to locations for charging, refueling and/or servicing the vehicle 105 and continuing to a second parking location at an end of the mission. Vehicle energy usage for a mission is an amount of energy, e.g., measured in joules, used by the vehicle 105 to complete a mission; expected vehicle energy usage for a mission is an amount of energy predicted to be used by the vehicle 105 to complete the mission. Location, as used herein, is a specified point on the surface of the earth, typically specified according to a conventional longitude-latitude pair of geo-coordinates.

The vehicle 105 includes a computer 110, sensors 115, actuators 120 to actuate components 125, sensor maintenance components 130, and a high-voltage (HV) traction battery 135. The vehicle 105 is communicatively coupled via a network 140 with one or more servers 145.

The computer 110 includes a processor and a memory such as are known. The memory includes one or more forms of computer-readable media, and stores instructions executable by the computer 110 for performing various operations, including as disclosed herein.

The computer 110 may operate the vehicle 105 in an autonomous, a semi-autonomous mode, or a non-autonomous (or manual) mode. For purposes of this disclosure, an autonomous mode is defined as one in which each of vehicle 105 propulsion, braking, and steering are controlled by the computer 110; in a semi-autonomous mode the computer 110 controls one or two of vehicles 105 propulsion, braking, and steering; in a non-autonomous mode a human operator controls each of vehicle 105 propulsion, braking, and steering.

The computer 110 may include programming to operate one or more of vehicle brakes, propulsion (e.g., control of acceleration in the vehicle 105 by controlling one or more of an internal combustion engine, electric motor, hybrid engine, etc.), steering, transmission, climate control, interior and/or exterior lights, etc., as well as to determine whether and when the computer 110, as opposed to a human operator, is to control such operations. Additionally, the computer 110 may be programmed to determine whether and when a human operator is to control such operations.

As described in additional detail below, the computer 110 is programmed, in some cases in coordination with the server 145, to manage energy usage of the vehicle 105 during a mission. Managing the energy usage includes determining a route of the mission and/or operating parameters for operating the vehicle 105 along the route based in part on energy considerations. Operating parameters for operating the vehicle 105 mean data values specifying physical quantities for operating the vehicle 105 such as rates of acceleration, rates of deceleration, target speeds, etc., that the computer 110 may implement and/or use as a limit when operating the vehicle 105. The energy considerations can include insuring that the vehicle 105 remains in a range to reach a charging station during and/or after completion of the mission based on available stored energy. The vehicle 105 range, as used herein, is the distance that the vehicle 105 can travel based on an amount of electrical energy stored in the vehicle 105 and/or an amount of fuel available for combustion.

The computer 110 may include or be communicatively coupled to, e.g., via a vehicle network such as a communications bus as described further below, more than one processor, e.g., included in electronic controller units (ECUs) or the like included in the vehicle 105 for monitoring and/or controlling components 125, e.g., a transmission controller, a brake controller, a steering controller, etc. The computer 110 is generally arranged for communications on a vehicle communication network that can include a bus in the vehicle 105 such as a controller area network (CAN) or the like, and/or other wired and/or wireless mechanisms.

Via the vehicle network, the computer 110 may transmit messages to various devices in the vehicle 105 and/or receive messages (e.g., CAN messages) from the various devices, e.g., sensors 115, an actuator 120, a human machine interface (HMI), etc. Alternatively, or additionally, in cases where the computer 110 comprises a plurality of devices, the vehicle network may be used for communications between devices represented as the computer 110 in this disclosure. Further, as mentioned below, various controllers and/or sensors 115 may provide data to the computer 110 via the vehicle 105 communication network.

Sensors 115 may include a variety of devices such as are known to provide data to the computer 110. For example, the sensors 115 may include light detection and ranging (lidar) sensor(s), etc., disposed on a top of the vehicle 105, behind a vehicle front windshield, around the vehicle 105, etc., that provide relative locations, sizes, and shapes of objects surrounding the vehicle 105. As another example, one or more radar sensors 115 fixed to the vehicle 105, e.g., to bumpers, may provide data to provide locations of the objects, second vehicles 105, etc., relative to the location of the vehicle 105. The sensors 115 may further alternatively or additionally include camera sensor(s), e.g. front view, side view, etc., providing images from an area surrounding the vehicle 105. Still further, the sensors 115 may include sensors to monitor a state of the vehicle such as voltage sensors and current sensors that can be used to monitor a charge in a battery, fluid level sensors to measure an amount of sensor cleaning fluid available for cleaning sensor apertures, etc.

Actuators 120 are implemented via circuits, chips, or other electronic and or mechanical components that can actuate various vehicle subsystems in accordance with appropriate control signals as are known. The actuators 120 may be used to control components 125, including braking, acceleration, and steering of a vehicle 105.

In the context of the present disclosure, a component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component, etc.

The vehicle 105 includes a variety of sensor maintenance components 130. Sensor maintenance components 130 are one or more hardware components adapted to perform an electrical, mechanical, or electro-mechanical function or operation to maintain operation of the sensors 115 during a mission such heating, cooling, and cleaning the sensors 115. Examples of sensor maintenance components 130 include pumps, fluid lines, and nozzles for delivering sensor cleaning fluid to the sensors 115, motors and wipers to remove dirt, insect matter, precipitation, etc. from the lenses of sensors 115, heating elements to defog the lenses of sensors 115, etc., as well as control modules for controlling these operations.

The high-voltage traction battery 135 stores electrical energy for the vehicle 105. The high-voltage traction battery 135 can receive electrical energy, for example from a charging station where the vehicle 105 is plugged into a power network. Additionally or alternatively, the high-voltage traction battery 135 can receive electrical energy from a generator operating in the vehicle 105. The high-voltage traction battery 135 outputs electrical energy to vehicle components 125 for vehicle propulsion such as a drive motor, and further to voltage conversion systems that convert the high-voltage energy from the high-voltage traction battery 135 to voltage levels that can be used by vehicle systems including the computer 110, sensors 115, actuators 120, components 125, sensor maintenance components 130, etc. in the vehicle 105. The vehicle 105 may include an independent cooling system dedicated to cooling the high-voltage traction battery 135.

The computer 110 may be configured for communicating via the network 140 to the server 145. The network 140 represents one or more mechanisms by which the computer 110 may communicate with the server 145. Accordingly, the network 140 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

The server 145 includes a processor and a memory such as are known. The memory includes one or more forms of computer-readable media, and stores instructions executable by the server 145 for performing various operations, including as disclosed herein. The server 145 may further include or be communicatively coupled to other servers that can provide data regarding an environment in which the vehicle 105 is operating. The data can include map data and telematics data.

Map data, as used herein, is data indicating the geographic location of substantially static features of the environment in which the vehicle 105 is operating such as terrain, roads, parking lots, traffic signals, bridges, buildings, charging and service stations, restaurants, speed limits (non-variable), access to communications networks, etc. Substantially static as used herein means typically not changing or moving over time.

Telematics data, as used herein, means data quantifying, over time, conditions of the environment above the ground in which the vehicle 105 is operating during the mission, and that can be provided in real or near real time, typically via wireless communications. Telematics data can thus measure temporally changing conditions, i.e., conditions that can change day-to-day, hour-to-hour, minute-to-minute, etc. Examples of conditions in the environment above the ground that may be temporally changing are weather conditions (ambient temperature, amount and type of precipitation, cloudiness, humidity, fog, etc.), time-of-day (daytime, nighttime, dusk, etc.), traffic conditions (length and location of expected delays, current speed of traffic, location of accidents, current speed limits for areas with dynamic speed limits), road construction, lane closures, detours and other conditions that may change day-to-day or one or more times during a day and can impact the mission.

The server 145 may be programmed to store or retrieve, e.g., from some other server, telematics data and to provide the data to the computer 110 upon request from the computer 110. Further, the server 145 may be programmed to perform a portion of the steps for estimating expected energy usage by the vehicle 105 during a mission, as described below.

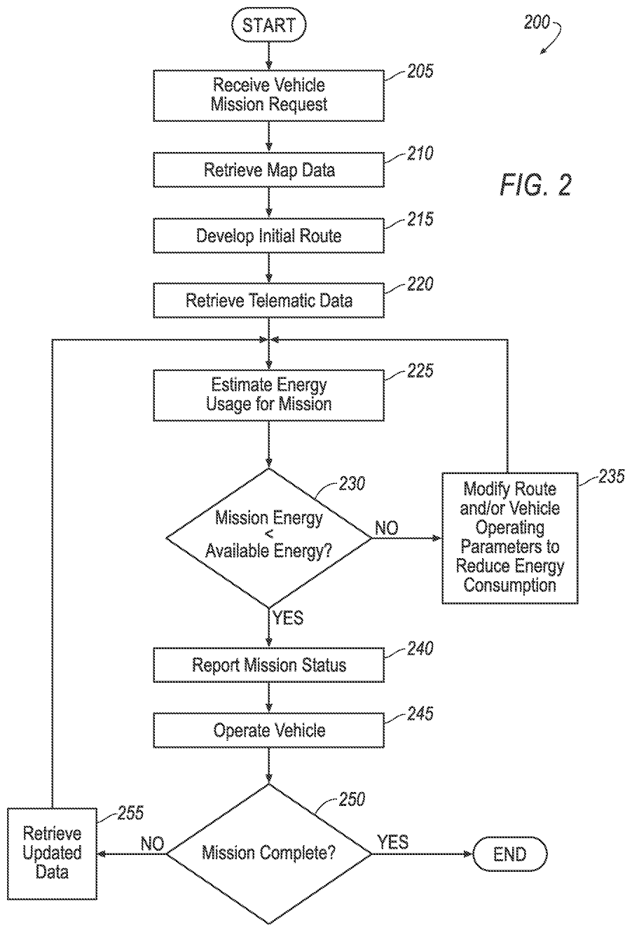

FIG. 2 is a flow diagram of an example process 200 for managing expected vehicle energy usage for a mission. For ease of understanding, the process 200 will be described as executed by the computer 110, wherein the computer 110 retrieves data from the server 145 regarding the environment in which the vehicle 105 is travelling. This description is not intended to be limiting. The server 145 can execute a portion or all of process 200 and can communicate the results to the computer 110. Further, other computers, communicatively coupled to the computer 110 and/or server 145 may execute a portion or all the process 200.

In the process 200, the computer 110 is programmed to receive a request for a mission including tasks for the mission as described below. The computer 110 executes and manages the mission based on the tasks and further based on a set of rules based upon which the computer 110 can plan and execute the mission.

For example, a non-limiting list of rules for a mission may include remaining in range to reach a charging station throughout the mission, minimizing recharging events, maintaining a sufficient level of sensor cleaning fluid to clean sensors 115 required for autonomous operation throughout the mission, maintaining passenger convenience features such as vehicle climate control throughout the mission, minimizing a delay until the vehicle 105 reaches a passenger, and avoiding areas that may be difficult for operating in an autonomous mode.

Some rules may be pre-programmed into the computer 110. Other rules may be received in the request for the mission. For example, the mission request may specify a start time for the mission, a time for arrival at one or more of the locations along a route of the mission, an end time of the mission, a type of driving, a time-of-day for the mission, a date for the mission, etc. The process 200 begins in a block 205.

In the block 205, the computer 110 receives a mission request including a set of tasks and may further include rules for the mission. As a non-limiting example, the request may include starting from a first location, which may be a terminal parking lot or depot, picking up a passenger(s) or cargo at one or more second locations, delivering the passenger(s) or cargo to one or more third locations, driving to one or more fourth locations for charging, fueling and/or servicing and then proceeding to a fifth location for parking. The request may further include timing information such as a start time for the mission, an end time for the mission, a date for the mission, etc. This example is not intended to be limiting. The mission may include more or fewer locations along the route. For example, the route may include one or more locations where the vehicle stops for fueling or servicing, or one or more locations where the vehicle stops so that a passenger can have a meal, use restrooms, etc. The process 200 continues in a block 210.

In the block 210, the computer 110 is programmed to retrieve map data. For example, the computer 110 may retrieve map data indicating available roads connecting the first location of the mission to the second location, the second location to the third location, etc. from a map database. The map database may be stored, for example, in memory included in the computer 110 and/or in the server 145.

The map data may include a plurality of waypoints (i.e., nodes) and segments (i.e., links). Waypoints are geographic locations on a map associated with features that affect route planning, such as road intersections, building addresses, entrances to parking lots, etc. A segment is a portion of a road or similar structure between two waypoints of the map.

For each segment, the map data may include metadata describing the segment. The metadata may include start and end points for the segment (in latitude and longitude coordinates), a length of the segment between its start and end waypoints, a type of road (dirt, paved, local, limited access), an angle of ascent/descent, an elevation, a location of traffic signals, speed limits, etc. The metadata may further include a location of charging stations, rest areas, restaurants, etc. Still further, the metadata for individual segment may include the availability of communications networks (WiFi, telecommunications services, etc.) along the segment and any other substantially static information (i.e., information that typically does not change over time) for planning a mission.

Upon retrieving the map data for the mission, the process 200 continues in a block 215. In the block 215, the computer 110 is programmed to generate an initial route based on the mission request and the map data. The computer 110 may generate a route segment table (RST) describing the initial route.

The route segment table contains information concerning the route that can be applied by the computer 110 to execute the mission. The information may include a complete list of waypoints and segments that describe the route intended for the mission. The vehicle 105 performs the mission by traversing the route segments in an ordered sequence. An example route segment table for the initial route appears in table 1, below.

TABLE 1
Initial Route Segment Table (RST)

| | | | | | | | | | | |
|---|---|---|---|---|---|---|---|---|---|---|
| | | | | | | | | | J | |
| | | | | | | | | I | Expected | K |
| | | | | | | | | Expected | Weather-Related | Total |
| | B | C | D | E | | | H | Time of | Energy | Route |
| | Initial | Final | Actual | Predicted | | | Expected | Day | Usage | Segment |
| A | Route | Route | Segment | Segment | F | G | Motive | Energy | (% SOC) | Energy |
| Route | Segment | Segment | Length | Speed | Segment | Time On | Energy | (% SOC) | Expected | (% SOC) |
| Segment | Waypoint | Waypoint | (miles) | (MPH) | Stop | Segment | (% SOC) | Expected | Weather- | Total |
| Number | Initial | Final | Actual | Predicted | Count | (seconds) | Expected | Time of | Related- | Route |
| Route | Route | Route | Segment | Segment | Segment | Time On | Motive | Day | Energy | Segment |
| Segment | Segment | Segment | Length | Speed | Stop | Segment | Energy | Energy | Usage | Energy |
| Number | Waypoint | Waypoint | (miles) | (MPH) | Count | (seconds) | (J) | (J) | (J) | (J) |

| | | |
|---|---|---|
| 1 | A | B |
| 2 | B | C |
| • | • | • |
| • | • | • |
| n | Y | Z |

Definitions of the columns of the table are:
Segment Number. A segment number specifies the order in which the routes segments are to be travelled.
Initial Segment Waypoint. An initial segment waypoint specifies a starting location of the route segment, e.g., specified as a longitude-latitude pair of geo-coordinates.
Final Segment Waypoint. A final segment waypoint specifies an ending location of the route segment, e.g., specified as a longitude-latitude pair of geo-coordinates.
Actual Segment Length. An actual segment length specifies a distance the vehicle 105 will travel on the road between the starting and ending waypoints.
Predicted Segment Speed. A predicted segment speed is a predicted average speed of the vehicle 105 on the segment in light of road conditions and traffic conditions.
Predicted Segment Stop Count. A predicted segment stop count is an estimate of a number of times the vehicle 105 will stop in the segment.
Time-on-Segment. A time-on-segment is an average length of time that the vehicle 105 will require to traverse the segment.
Expected Motive Energy Usage. A predicted motive energy usage is an estimated amount of energy the vehicle 105 will use to traverse the segment at the predicted segment speed, with the expected number of stop events, in the presence of the road conditions and traffic conditions provided by telematics data. The expected motive energy-usage estimate also includes the effects of the terrain encountered on the route segment (e.g., hills and valleys).
Expected Time-of-Day Energy Usage. A predicted time-of-day energy usage is an estimated amount of energy the vehicle 105 will use for interior and exterior lighting due to dusk, dawn, or nighttime conditions.
Expected Weather-Related Energy Usage. A predicted weather-related energy usage is an estimated amount of energy usage for the vehicle subsystems that are active in various weather conditions, including sensor heating, cooling, and cleaning; passenger climate control (air conditioning or heating); and heated or cooled seats.
Total Route Segment Energy. A predicted total amount of energy used on the route segment.

As shown in Table 1, the initial route segment table may only include values for columns A-C. The computer 110 may determine values for and populate columns D-K based on energy considerations, as described below. Upon generating the initial route segment table describing an initial route for the mission, the process 200 continues in a block 220.

In the block 220, the computer 110 is programmed to retrieve telematics data. The process continues in a block 225.

In the block 225, the computer 110 is programmed to estimate an energy usage for the mission based on a current proposed route, current operating parameters for the vehicle 105, the map data, and the telematics data. In a first iteration, the current proposed route may be the initial route as specified by the computer in the block 215 and the current operating parameters may be, for example, default parameters for operating the vehicle 105. In second and following iterations, the current proposed route may be a modified route and the current proposed operating parameters may be modified operating parameters, as determined in a block 235, below.

The computer 110 then estimates the expected vehicle energy usage for the mission. As an example, the computer 110 may be programmed to execute a process 300, described below. The computer 110 may update the route segment table to include data related to expected energy usage on a segment-by-segment basis. An example updated route segment table is shown in Table 2 below.

TABLE 2

| | | | Generated by Mission Energy Planner | | | | | | | |
|---|---|---|---|---|---|---|---|---|---|---|
| Generated by Path Planner | | | | | | | | I | J | K |
| | B | C | D | E | | | H | Expected | Expected | Total |
| A | Initial | Final | Actual | Predicted | F | G | Expected | Time of | Weather-Related | Route |
| Route | Route | Route | Segment | Segment | Segment | Time On | Motive | Day | Energy | Segment |
| Segment | Segment | Segment | Length | Speed | Stop | Segment | Energy | Energy | Usage | Energy |
| Number | Waypoint | Waypoint | (miles) | (MPH) | Count | (seconds) | (% SOC) | (% SOC) | (% SOC) | (% SOC) |
| 1 | A | B | 3.5 | 15.6 | 3 | 808 | 0.5 | 0.01 | 0.01 | 0.52 |
| 2 | B | C | 10.2 | 30.1 | 5 | 1220 | 1.2 | 0.5 | 1.5 | 3.2 |
| • | • | • | • | • | • | • | • | • | • | |
| • | • | • | • | • | • | • | • | • | • | |
| n | Y | Z | 16.2 | 2.1 | 12 | 2222 | 3.1 | 0.04 | 2.5 | 5.64 |

The process 200 continues in a block 230.

In the block 230, the computer 110 is programmed to determine whether the expected vehicle energy usage for the mission is less than an available energy for the vehicle 105. In an example, the available energy for the mission may be the energy stored in the high-voltage traction battery 135. In another example for a hybrid electric vehicle including an engine and generator, the available energy may include the energy stored in the high-voltage traction battery 135 plus energy available from converting fuel to electrical energy by the generator.

In the case that the computer 110 determines that the expected vehicle energy usage for the mission is less than the available energy for the mission, the process 200 continues in a block 240. In the case that the expected vehicle energy usage for the mission is greater than the available energy for the mission, the process 200 continues in a block 235.

In the block 235, the computer 110 is programmed to modify a route and/or operating parameters of the vehicle 105 to reduce energy usage during the mission and/or to provide for recharging the vehicle 105 during the mission. For example, the computer 110 may identify segments along the route that require increased energy usage (e.g., energy usage higher than an amount expected for the segment based on historical and/or statistical data) based on an expected condition above the ground along the route. The expected condition may be, for example, an expected traffic condition (e.g., a traffic back-up due to an accident), an expected weather condition (e.g., a back-up due to slippery road conditions on a hill, an expected reduced driving speed along the segment due to limited visibility), etc. The computer 110 may select an alternate route that avoids these segments and reduces expected total mission energy usage. The computer 110 may further be programmed to adjust vehicle operating parameters. For example, the computer 110 may be programmed to reduce the speed of the vehicle 105 along segments of the route, and/or reduce rates of acceleration of the vehicle 105 to conserve energy. As another example, the computer 110 may determine that, based on the current estimate of energy usage for the mission, the vehicle 105 should be recharged during the mission, and the computer 110 can then add a stop during the mission for recharging. The process 200 continues in the block 225.

In the block 240, the computer 110 is programmed to report a mission status to a display and/or a computing device such as the server 145. For example, the computer 110 may report an estimated amount of time before the vehicle 105 arrives at a passenger pick-up location, an estimated amount of time until arriving at a drop-off location, etc. The process 200 continues in a block 245.

In the block 245, the computer 110 is programmed to operate the vehicle 105 along the current route and according to current vehicle operating parameters (i.e., the initial route and initial vehicle operating parameters identified in the block 215 or a modified route and modified operating parameters identified in the block 235). The process 200 continues in a block 250.

In the block 250, the computer 110 is programmed to determine if the vehicle 105 has completed its mission. In the case that the vehicle 105 has completed its mission, the process 200 ends. Otherwise, the process continues in a block 255.

In the block 255, the computer 110 is programmed to collect one or more of updated telematics data, updated vehicle data and/or updated map data. For example, the computer 110 may retrieve updated telematics data such as traffic conditions, weather conditions, light conditions, etc. along the remainder of the route for the mission. The remainder of the route for the mission is defined as those segments of the route that have not yet been travelled by the vehicle 105. The computer 110 may further retrieve updated vehicle data. Vehicle data may include an amount of charge in the high-voltage traction battery 135, an amount of fuel available, for example in a case of the vehicle 105 including a combustion engine, an amount of sensor cleaning fluid available, and any service requirements for the vehicle 105. In a case that there is a change to the mission that requires additional map data, such as a stop at an additional location not included in the current map data, the computer 110 may further retrieve updated map data. The process 200 continues in the block 225.

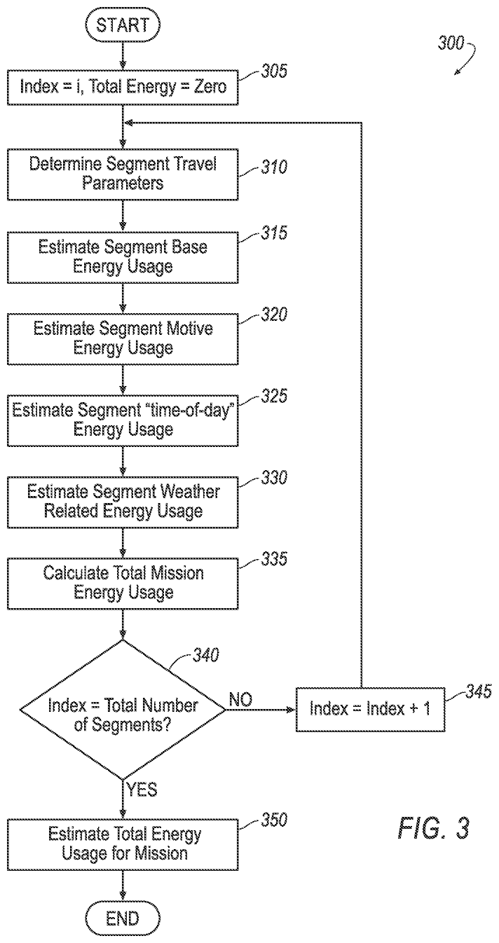

FIG. 3 is flow diagram of an example process 300 for estimating expected energy usage for a mission. As described below, the process 300 estimates the expected vehicle energy usage for individual segments along the route of the mission, and then totals the segment energy usages to determine a total expected vehicle energy usage for the mission. In a case where the mission is on-going, the process 300 is iterative and can update an expected vehicle energy usage for a remainder of the mission with each iteration. The computer 110 may be programmed, for example, to start a new iteration upon completing a segment in the route segment table and starting a next segment. As another example, the computer 110 may be programmed to start a new iteration periodically (for example, once per minute or once per five minutes) during the mission. In this case, the computer 110 may predict an energy usage for a portion of the current segment not yet travelled, and then predict the energy usage for the remaining segments in the current route. The process 300 may be initiated by the block 225 of the process 200. The process 300 begins in a block 305.

In the block 305, the computer 110 is programmed to initialize a segment index to the next segment i to be travelled by the vehicle 105. In the case that the computer 110 invokes the process 300 during a mission planning phase, the next segment i will be the first segment (i.e., segment number 1) of the route segment table. In a case where the computer 110 invokes the process 300 during an on-going mission, the computer 110 can be programmed to initialize the segment index to be the next segment i to be travelled by the vehicle 105 according to the route segment table. The computer 110 is further programmed to initialize an expected vehicle energy usage calculation by setting an expected vehicle energy usage variable to zero. The process 300 continues in a block 310.

In the block 310, the computer 110 is programmed to calculate segment parameters associated with the indexed segment in the route segment table. The segment parameters calculated by the computer 110 include an actual segment length, a predicted segment speed, a segment stop count and a time-on-segment.

The actual segment length is a function of the starting and end waypoints, and any detours reported to the computer 110 through telematics data. In the case that the telematics data indicates that a route segment in the route segment table is not available (e.g., a road is closed), the computer 110 replaces that segment with an alternate set of segments required by the detour. The computer 110 determines the actual segment length to be a length of the proposed route segment if no detour is needed or alternately, a substitute set of segments reflecting the detour, and the length of each segment included in the detour.

The computer 110 is programmed to determine a predicted average speed of the vehicle 105 on the indexed segment based on (1) speed limits including time-of-day speed limits (e.g., school zones), (2) road conditions and (3) traffic conditions. The computer 110 is programmed to estimate a predicted average speed of the vehicle 105 along the segment based on road conditions, weather conditions, traffic conditions and other factors. For example, the computer 110 may divide the segment into a plurality of sub-segments Sₙ where n is a positive integer and a sub-segment index. Each sub-segment Sₙ may have or be assigned a length wₙ, and a speed limit slₙ. Based on the assigned length wₙ, the assigned speed limit slₙ, road conditions and traffic conditions, the computer 110 may predict a time tₙ to traverse the sub-segment Sₙ.

For example, for sub-segments Sₙ where traffic is flowing freely, the computer 110 may predict the time tₙ to traverse the sub-segment Sₙ to be the equal to, for example, (a)(b)(wₙ)/(slₙ), where a is a factor to account for weather conditions and b is a factor to account for road conditions.

Alternatively, for sub-segments Sₙ where the speed is limited by the speed of traffic, the time tₙ to traverse the sub-segment may be equal to (wₙ)(speed of traffic for segment Sₙ)

The computer 110 can then determine the predicted average speed for the segment to be a total length of the segment W divided by the sum of the times t₁+t₂+ . . . tₘ, where m is a positive integer two or greater and the number of sub-segments in the segment. That is: predicted average segment speed=W/(t₁+t₂+ . . . tₘ).

Road conditions are obtained from telematics data and are also estimated based on weather conditions. Road segments may require a reduced driving speed due to construction. Further, the average speed of the vehicle 105 can be impacted by changing features in the environment. For example, for operating the vehicle 105 in an autonomous mode, the computer 110 relies on prior maps based on lidar data. If the area surrounding a road is altered due to building construction, transient objects (e.g., objects parked near the road in areas empty when the map was acquired), or similar factors, the computer 110 may reduce vehicle speed to enable the computer 110 to recognize, and adapt to, the surrounding area. In these cases, the predicted time to traverse an affected sub-segment may be adjusted by an additional factor to account for computational considerations.

Traffic conditions are also obtained from telematics data. Congested traffic reduces the average vehicle speed on the route segment, and vehicle energy usage is proportionately increased.

The computer 110 is further programmed to determine a segment stop count. The segment stop count is an estimated number of times the vehicle 105 will stop during the segment and is affected by road and traffic conditions. In a case that the vehicle 105 includes a regenerative braking system, the vehicle 105 can recapture energy during braking operations. The segment stop count allows the computer 110 to estimate an amount of energy recovered during braking operations along the segment.

The computer 110 can be further programmed to determine a time-on-segment, T_{on-segment}. T_{on-segment} is an estimated time that the vehicle 105 will spend on the indexed segment based on the estimated segment speed, actual segment length and estimated segment stop count, and is typically expressed in seconds. Upon calculating the segment travel parameters, the process 300 continues in a block 315.

In the block 315, the computer 110 is programmed to calculate an expected base load energy usage E_{baseload} by the vehicle 105 during travel on the indexed segment. The expected base load energy usage E_{baseload} is an estimated energy usage by the vehicle 105 on the indexed segment for vehicle systems and sub-systems that are active whenever the vehicle is in a key-on state and draw a substantially constant amount of electrical power regardless of the actions being performed by the vehicle 105 (i.e., idling at a stop, cruising on a highway, etc.) Non-limiting examples of these loads include electronic control modules (ECUs) such as an engine control module, a hybrid high-voltage traction battery control module, a body control module and a restraints control module, sensors 115 such as oil pressure sensors, engine cooling sensors, entertainment systems, and communications systems.

The total energy consumed by these devices during a given route segment is a function only or substantially only of the time-on-segment T_{on-segment} and can be expressed according to equation 1 as follows:

E_{baseload}=(P_{baseloads})(T_{on-segment}) Eq. 1

where
P_{baseloads} is the power consumed by vehicle 105 base electrical loads (watts), and
T_{on-segment} is the estimated time that the vehicle 105 will spend on the indexed segment (seconds).

The energy consumed by each load may vary based on software revision level and the calibration of various vehicle features. Each vehicle 105 may contain a distinct set of devices based on the vehicle platform and optional electrical content of the vehicle 105, and hence the base load energy usage may vary on a vehicle-by-vehicle basis. The expected base load energy usage E_{baseload} may be calculated based on models developed for the vehicle 105 during the design phase. Models, as used herein, may be a set of algorithms and parameters that predict a performance of a vehicle system based on operating conditions and may include algorithms to predict an energy usage for the system based on, for example, a time of operation, weather conditions such ambient temperature during operation, ambient light conditions, vehicle speed, etc. In the block 315, the computer 110 may apply a model for the base loads that draw a substantially constant amount of electrical power regardless of the actions being performed by the vehicle 105 to calculate a predicted energy usage the for system or subsystem and then total them to determine the expected baseload energy usage. Upon determining the expected base load energy usage E_{baseload} for the indexed segment, the process 300 continues in a block 320.

In the block 320, the computer 110 is programmed to calculate an expected motive energy usage Eₘₒₜᵢᵥₑ of the vehicle 105 during travel on the indexed segment due to loads that become activated when the vehicle 105 is in motion (Loadsₘₒₜᵢᵥₑ). Non-limiting examples of Loadsₘₒₜᵢᵥₑ are:
Power steering motors especially during low speed maneuvers,
Brake pressure pumps and related actuators, especially in rapid deceleration conditions,
High-voltage traction battery 135 loads when the vehicle 105 moves from a stand-still in an electric-only mode, and
an engine cooling fan.

Additionally, in a case that the vehicle 105 is operating in an autonomous mode, loads that contribute to Eₘₒₜᵢᵥₑ can include:
Computer (e.g., computer 110) complex calculations during sophisticated vehicle maneuvers, and
Computer cooling system loads due to the abovementioned complex calculations.

The expected motive energy usage Eₘₒₜᵢᵥₑ is based on the actual segment length, the estimated segment speed, the estimated segment stop count and the terrain covered by the indexed segment. For example, the computer 110 may calculate the expected motive energy usage according to equation 2 as follows:

Eₘₒₜᵢᵥₑ=E_{motive_base}+E_{acc_dec}+Eₑₗᵥₐₜᵢₒₙ Eq. 2

where:
Eₘₒₜᵢᵥₑ is the expected energy usage by the vehicle 105 Loadsₘₒₜᵢᵥₑ for the segment,
E_{motive_base} is the estimated energy usage of the Loadsₘₒₜᵢᵥₑ per unit distance on a flat road at the average segment speed times the length of the segment,
E_{acc_dec} is the expected incremental energy usage of the Loadsₘₒₜᵢᵥₑ due to acceleration and deceleration during the segment, and
Eₑₗₑᵥₐₜᵢₒₙ is the expected incremental energy usage of the Loadsₘₒₜᵢᵥₑ due to elevation changes during the segment.

Each of these factors may be adjusted for weather conditions and traffic conditions. The individual elements may be calculated as follows.

E_{motive_base} may be calculated, for example, to be the energy usage by the Loadsₘₒₜᵢᵥₑ per unit distance on a flat road at the average expected segment speed times the length of the segment.

E_{acc_dec} may be calculated, for example, as an average energy usage of the Loadsₘₒₜᵢᵥₑ for an acceleration times a number of expected accelerations minus an incremental energy recovery for each deceleration×the number of expected decelerations. The number of expected accelerations and decelerations may be estimated based on the estimated vehicle stop count for the segment and/or based on statistical data for vehicles 105 traversing the segment.

Eₑₗₑᵥₐₜᵢₒₙ may be calculated, for example, as (an incremental energy usage by the Loadsₘₒₜᵢᵥₑ per unit increase in elevation at the average segment speed)×(a total amount of incline during the segment (a sum of all of the uphill travel))−an incremental energy recovery Loadsₘₒₜᵢᵥₑ per unit decrease in elevation at the average segment speed×(a total amount of decline during the segment (a sum of all of the downhill travel)).

The computer 110 can be programmed to utilize data that characterizes the Loadsₘₒₜᵢᵥₑ of the vehicle 105 to calculate the expected motive energy usage Eₘₒₜᵢᵥₑ. For example, during development, data for a vehicle type corresponding to the vehicle 105 may be collected under a wide range of conditions. This data may include:
1. Energy usage of the Loadsₘₒₜᵢᵥₑ per unit distance while driving on flat roads at a range of vehicle speeds.
2. Energy usage and recovery of the Loadsₘₒₜᵢᵥₑ as the vehicle 105 accelerates to a specific speed and then brakes to a halt (i.e., the performance of the regenerative brake system).
3. Energy usage of the Loadsₘₒₜᵢᵥₑ per unit distance on hills with various ascending and descending grades for a range of vehicle speeds and regenerative braking energy recovery by the Loadsₘₒₜᵢᵥₑ when moving downhill using the brakes.

This data is available to the mission energy planner in the form of equations and data tables. As an example, an equation to calculate energy usage per unit distance on a hill may be energy usage per unit distance at a base speed at a base rate of incline (a first factor for speed deviation from the base speed)*(a second factor for deviation from the base rate of incline). The base speed may be, for example, 35 miles per hour. The base rate of incline may be, for example, 0 degrees (a flat road). The computer 110 may maintain a table for each of the factors for the vehicle type corresponding to the vehicle 105. Here is an example (from among many possible):

Factor for adjusting energy usage based on
deviation from base speed (35 miles/hour)

| deviation (miles/hour) | Factor |
|---|---|
| −25 | 0.3 |
| −5 | 0.8 |
| 0 | 1 |
| +5 | 1.2 |
| +25 | 1.8 |

Factor for adjusting energy usage based on deviation
from base rate of incline (0 degrees)

| deviation (in degrees) | Factor |
|---|---|
| −9 | 0.1 |
| −1 | 0.9 |
| 0 | 1 |
| +1 | 1.1 |
| +10 | 2 |

For each segment of the route segment table, the computer 110 may be programmed to:
1. Calculate E_{motive_base} equal to the energy usage by the Loadsₘₒₜᵢᵥₑ per unit distance on a flat road at the average expected segment speed×the length of the segment.
2. Calculate E_{acc_dec} of the Loadsₘₒₜᵢᵥₑ due to acceleration/deceleration equal to an average energy usage of the Loadsₘₒₜᵢᵥₑ for an acceleration×a number of expected accelerations minus an incremental energy recovery of the Loadsₘₒₜᵢᵥₑ for each deceleration×the number of expected decelerations.
3. Calculate Eₑᵢₑᵥₐₜᵢₒₙ of the Loadsₘₒₜᵢᵥₑ along the segment equal to (an incremental energy usage of the Loadsₘₒₜᵢᵥₑ per unit increase in elevation at the average segment speed)*(a total amount of incline during the segment)−an incremental energy recovery of the Loadₘₒₜᵢᵥₑ per unit decrease in elevation at the average segment speed*(a total amount of decline during the segment).
4. Calculate the expected motive energy usage according to equation 2, copied from above for convenience.

Eₘₒₜᵢᵥₑ=E_{motive_base}+E_{acc_dec}+Eₑₗₑᵥₐₜᵢₒₙ Eq. 2

The process 300 continues in a block 325 in which the computer 110 calculates an expected time-of-day energy usage E_{TOD} by the vehicle 105 during travel on the indexed segment. The expected time-of-day energy E_{TOD} is the incremental energy used by loads that are active based on ambient light conditions (Loads_{TOD}) during the segment. Non-limiting examples of Loads_{TOD} include:
Low-beam and high beam headlamps,
Passenger-controlled interior lighting, such as reading lamps and foot-well lighting (also referred to as “ambient lighting”.)
External displays whose lighting intensity level is adjusted based on ambient light level.

A vehicles 105 operating in an autonomous mode can be programmed to utilize external lighting to communicate with persons outside the vehicle 105 and for advertising. The computer 110 may be programmed to adjust these displays to be bright enough during the day that the displays can be seen in sunlight. Typically, this can be a maximum brightness setting for the external lighting and corresponds to a power consumption determined from vehicle data obtained during vehicle development and testing. The computer 110 may further be programmed to reduce external lighting intensity in night-time or other low-ambient-light conditions to avoid distracting drivers of other vehicles 105.

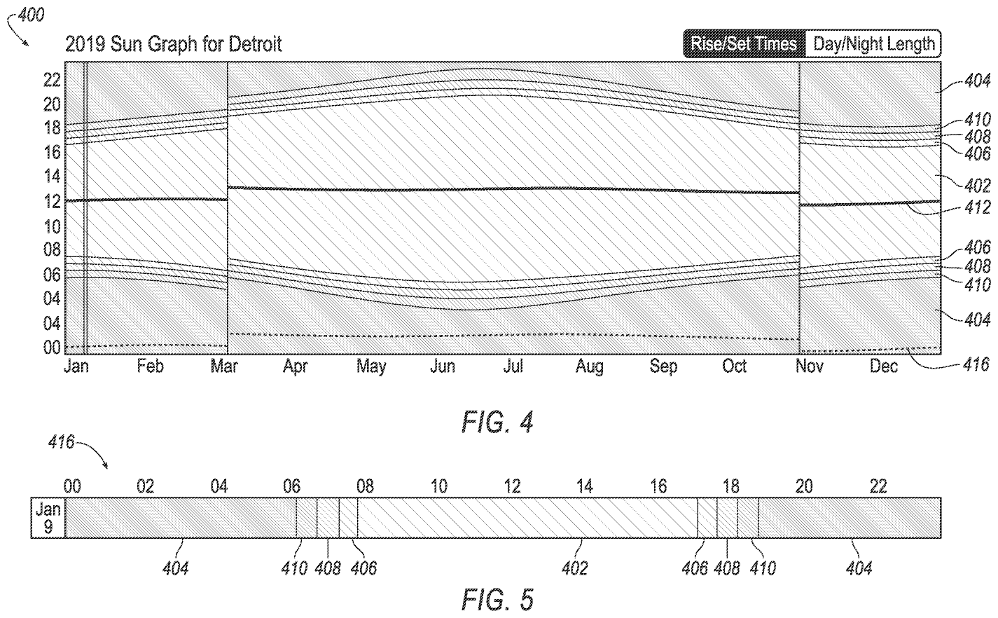

The computer 110 can be programmed to estimate time-of-day energy usage E_{TOD} based on existing data concerning lighting conditions as a function of day within a year and geographic location. FIGS. 4 and 5 illustrate typical sunrise/sunset data for Detroit, Mich.

FIG. 4 is an example graph 400 of the sun in Detroit, Mich. for the year 2019. Graph 400 may be derived, for example, from data from the National Oceanic and Atmospheric Administration (NOAA) data that provides the time that dusk, nighttime, and dawn conditions occur each day at geographic locations in the United States.

An area 402 in the graph 400 indicates daylight. Area 404 indicates nighttime. Areas 406 indicate civil twilight. Civil twilight is a period that begins in the morning and ends at night when the geometric center of the sun is 6° below the horizon. Areas 408 indicate nautical twilight. Nautical twilight is a period that begins in the morning and ends in the evening when the geometric center of the sun is 12° below the horizon. Areas 410 indicate astronomical twilight. Astronomical twilight is a period that begins in the morning and ends in the evening when the geometric center of the sun is 18° below the horizon. The line 412 indicates solar noon and the line 414 indicates solar midnight. An area 416 indicates a single day, in this case, Jan. 9, 2019.

FIG. 5 is an expanded view of the area 416 from FIG. 4. Based on time data from FIG. 5, the computer 110 can determine when each of daylight area 402, nighttime area 404, civil twilight area 406, nautical twilight area 408 and astronomical twilight area 410 begin and end on a day in a location, such as, in this case, Jan. 9, 2019 in Detroit, Mich. Example times of day for each of the areas 402, 404, 406, 408, 410 can be seen in table 3, below:

TABLE 3

| Area | Description | Time(s) |
|---|---|---|
| 402 | Daylight | 8:00am to 5:18pm |
| 404 | Nighttime | 12:00am to 6:20am |
| | | 6:58pm to 12:00am |
| 406 | Civil Twilight | 7:29am to 8:00am |
| | | 5:18pm to 5:49pm |
| 408 | Nautical Twilight | 6:54am to 7:29am |
| | | 5:49pm to 6:24pm |
| 410 | Astronomical Twilight | 6:20am to 6:54am |
| | | 6:24pm to 6:58pm |

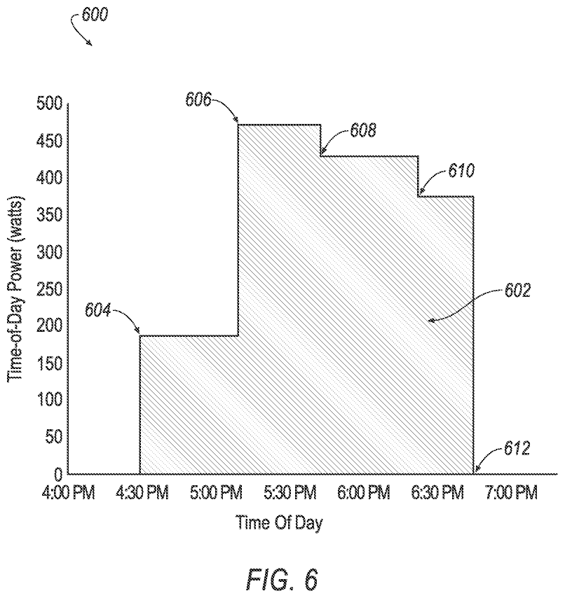

FIG. 6 is a diagram 600 illustrating an example of how sunrise and sunset data can be used to estimate the time-of-day energy E_{TOD_mission} for a vehicle mission. Time-of-day energy E_{TOD_mission} is the time-of-day energy required by the vehicle 105 for a mission. In the example of FIG. 6, the vehicle mission begins at 4:30 pm on January 9^{th} in Detroit Mich.

An area 602 indicates an energy usage in watts of time-of-day loads Loads_{TOD} at each time during the vehicle mission.

At 4:30 pm, at reference point 604, the mission starts. Based on the data from FIGS. 4 and 5, the vehicle 105 is operating in daylight. The vehicle 105 external displays are operating at a full brightness level. At 5:18 pm, reference point 606, the low beam headlamps are activated in response to the decreasing ambient light level at the beginning of civil twilight. The computer 110 may be programmed to assume, for example, that a user will also activate reading lamps and other interior lamps at this time. At the beginning of nautical twilight, reference point 608, the computer 110 may be programmed to reduce the brightness of external displays to avoid distracting other vehicles 105. At the beginning of astronomical twilight, reference point 610, the computer 110 may be programmed to further reduce the brightness of the vehicle 105 external display. The mission ends at the reference point 612 and all time-of-day energy loads LoadsToD are turned off.

According to the above example, the computer 110 can be programmed to estimate the time-of-day energy consumption of the mission according to various factors such as specified in equation 3 below:

E_{TOD_mission}=P_{ext_display_daylight}×(T_{daylight}+T_{civ_twilight})+P_{ext_display_naut_twilight}×T_{naut_twilight}+P_{ext_display_astro_twilight}×T_{astro_twilight}+P_{ext_display_night}×T_{night}+P_{headlamps}×(T_{civ_twilight}+T_{naut_twilight}+T_{astro_twilight}+T_{night})+P_{int_lighting_daytime}×T_{daytime}+P_{int_lighting_civ_twilight}×T_{civ_twilight}+P_{int_lighting_naut_twilight}×T_{naut_twilight}+P_{int_lighting_astro_twilight}×T_{int_lighting_astro_twilight}+P_{int_lighting_night}×T_{night} (Joules) Eq. 3

where:
E_{TOD_mission}=total on-cycle energy used for vehicle subsystems whose operation is affected by ambient light level (joules).
P_{ext_display_daylight}=power used by external displays when the vehicle is in daytime ambient lighting conditions (watts).
P_{ext_display_naut_twilight}=power used by external displays when the vehicle is in nautical twilight ambient lighting conditions (watts).
P_{ext_display_astro_twilight}=power used by external displays when the vehicle is in astronomical twilight ambient lighting conditions (watts).
P_{ext_display_night}=power used by external displays when the vehicle is in nighttime ambient lighting conditions (watts).
P_{headlamps}=power used by headlamps (watts).
P_{int_lighting_daytime}=power used by interior lighting when the vehicle is in daytime ambient lighting conditions (watts).
P_{int_lighting_civ_twilight}=power used by interior lighting when the vehicle is in civil twilight ambient lighting conditions (watts).
P_{int_lighting_naut_twilight}=power used by interior lighting when the vehicle is in nautical twilight ambient lighting conditions (watts).
P_{int_lighting_astro_twilight}=power used by interior lighting when the vehicle is in astronomical twilight ambient lighting conditions (watts).
P_{int_lighting_night}=power used by interior lighting when the vehicle is in nighttime ambient lighting conditions (watts).
T_{daylight}=length of time the vehicle operates in daytime ambient lighting conditions (seconds).
T_{civ_twilight}=length of time the vehicle operates in civil twilight ambient lighting conditions (seconds).
T_{naut_twilight}=length of time the vehicle operates in nautical twilight ambient lighting conditions (seconds).
T_{astro_twilight}=length of time the vehicle operates in astronautical twilight ambient lighting conditions (seconds).
T_{nighttime}=length of time the vehicle operates in nighttime ambient lighting conditions (seconds).

For the indexed route segment, the computer 110 can be programmed to determine which energy terms apply to the indexed route segment, and multiple the energy terms by the expected time to cross the segment T_{on-segment}. For example, according to the example of FIG. 6, in a case that the vehicle 105 is traversing the route segment during the daylight, the computer 110 can be programmed to calculate the time-of-day energy E_{TOD} for the segment according to equation 4.

E_{TOD} (for segment during daytime)=P_{ext_display_daylight}×T_{on-segment} Eq. 4

In addition to time-of-day external light energy usage, the expected time-of-day energy E_{TOD} may also include the use of external lighting due to regulatory requirements across the United States. Some states mandate the use of daytime-running lights. If the vehicle 105 is operated in these locations, the computer 110 can include the energy associated with local regulations in calculating the expected time-of-day energy E_{TOD}.

The process 300 continues in a block 330 in which the computer 110 is programmed to calculate an expected weather-related energy usage E_{weather} for the vehicle 105. The expected weather-related energy usage E_{weather} is an estimated incremental energy used by the vehicle 105 due to weather conditions and includes estimated energy required to mitigate the effects of weather on the passenger (through climate control system operation) and sensor cleaning. The computer 110 is programmed to calculate the estimated weather-related energy usage E_{weather} based on commercially available weather data and vehicle specifications. Weather conditions include ambient temperature and precipitation. Incremental energy used due to weather-related conditions means increases or decreases in energy usage due to differences in the ambient temperature from the base temperature, due to precipitation, and due to other factors (humidity, barometric pressure, etc.).

As an example, the estimated weather-related energy usage E_{weather} may be calculated based on equation 5, below:

E_{weather}=E_{cabin_loads}(T_{target},T_{ambient})+E_{sensor_maint}(T_{precip},R_{precip},T_{sensor_tgt},T_{ambient})+E_{module}(T_{mod_tgt},T_{ambient})+E_{HV} (T_{HV_tgt},T_{ambient}) Eq. 5

where:
E_{cabin_loads}=energy required for cabin climate control (Joules)
T_{target}=the target cabin temperature (centigrade degrees)
T_{ambient}=the ambient temperature of the vehicle environment (centigrade degrees)
E_{sensor_maint}=total energy required for sensor cleaning.
T_{precip}=the temperature of precipitation
R_{precip}=the precipitation rate (inches per hour).
T_{sensor_tgt}=the target temperature for a sensor
E_{module}=total energy required to maintain module operating temperature
T_{mod_tgt}=the target temperature for control modules
E_{HV}=energy to maintain HV traction battery 135 operating temperature
T_{HV_tgt}=the target temperature for the HV traction battery 135

The computer 110 can be programmed to calculate the energy required for cabin climate control based on weather data and vehicle 105 specifications. The weather data may be based, for example, on forecasts from National Oceanic and Atmospheric Administration (NOAA). The weather data may include, for example, an expected ambient temperature T_{ambient} on an hourly basis for a location on a selected day. The computer 110 can be programmed to request and receive this weather data, for example from the server 145.

Vehicle specifications, as used herein, means data and models, obtained or created during the design and testing phases of a vehicle development that specify the performance, including the thermal performance, of the vehicle 105 and vehicle sub-systems. For example, the vehicle specifications may specify the thermal performance of the vehicle cabin, vehicle control modules, the vehicle high-voltage traction battery 135, etc. The thermal performance may specify, for example, the amount of energy from the high-voltage traction battery 135 required to heat or cool the vehicle sub-system such as the vehicle cabin, vehicle control module, or vehicle high-traction battery 135 by a specific amount relative to a starting temperature or an ambient temperature. The models include equations that can be utilized by the computer 110 to determine an amount of energy required to heat or cool the vehicle sub-systems as a function of ambient temperature. The computer 110 can apply these models, along with weather forecasts from the National Oceanic and Atmospheric Administration (NOAA) to estimate incremental energy needed for these functions on each route segment.

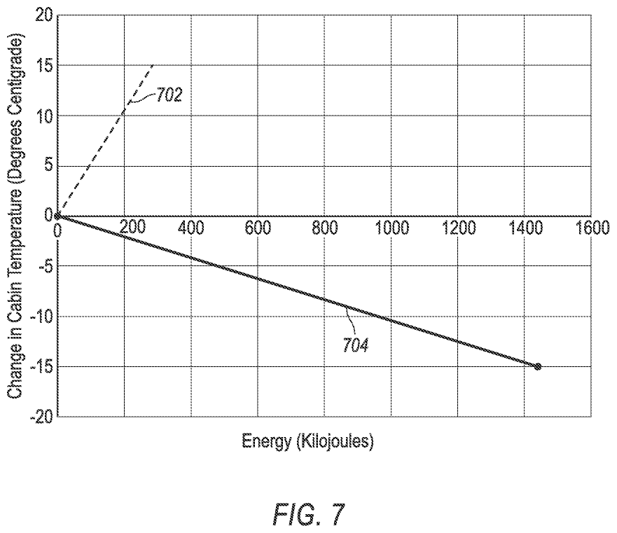

FIG. 7 is an example of a vehicle specification that specifies the energy to increase or decrease passenger cabin temperature for a fixed sun-load and ambient temperature. The curve 702 specifies the amount of energy to increase the cabin temperature a number of degrees centigrade. The curve 704 specifies the amount of energy to decrease the cabin temperature by a number of degrees centigrade.

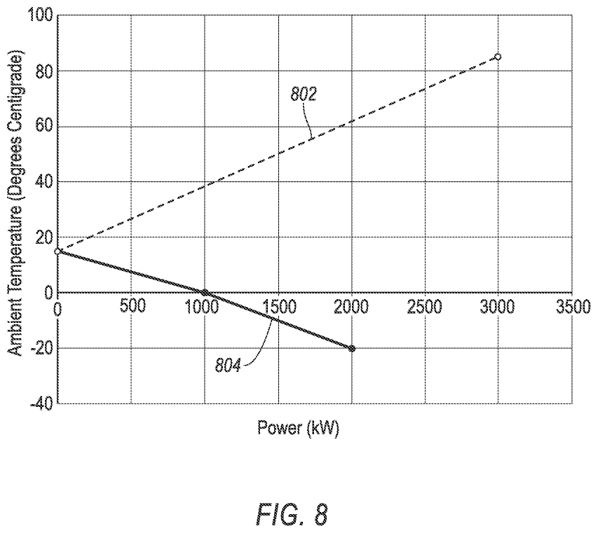

The computer 110 can be programmed to receive data indicating the ambient temperature T_{ambient} from weather data. The computer 110 can further be programmed to receive or determine the cabin target temperature T_{target}. For example, the cabin target temperature T_{target} can be a default value (typically, 23° C.), or may be a temperature input by a user of the vehicle 105. Based on the ambient temperature T_{ambient} and the target temperature T_{target}, the computer 110 can look-up the required energy to heat or cool the cabin using data such as the data in FIG. 8.

In addition to the energy required to attain the desired cabin temperature (i.e., to pull up or pull down the cabin temperature), energy is required to maintain the cabin temperature within a specified range for the duration of the mission. The specified range may be, for example, the target temperature T_{target}+/−0.5° C. This is typically a fixed energy expenditure per unit time.

Accordingly, E_{cabin_loads} can be estimated according to equation 6, below.

E_{cabin_loads}(T_{target},T_{ambient})=E_{PUPD}(T_{target}−T_{ambient})+Pₛₛ(T_{target}−T_{ambient})×Tₘᵢₛₛᵢₒₙ Eq. 6

where:
Pₛₛ (T_{target}-T^{ambient}) is the steady state power required to maintain the cabin temperature in the presence of the difference between T_{target} and L_{ambient} (watts per degree centigrade difference), and Tₘᵢₛₛᵢₒₙ is the duration of the mission (seconds).

It can be understood that, alternatively, E_{cabin_loads} and Pₛₛ can be expressed as parametric equations that take into account factors such as non-linear vehicle temperature pull-down and pull-up energy requirements (due, for example, to differences in the thermal mass of interior components), or sun-load effects. The empirical data necessary to create these equations is collected during normal vehicle development testing.

Vehicles 105 operating in an autonomous mode rely on data from a variety of sensors 115 (e.g., video cameras and LIDARs) to navigate and control the vehicle 105. These sensors 115 view the environment surrounding the vehicle 105 through optical apertures in a tiara. In adverse weather conditions, these apertures must be kept free of precipitation (e.g., snow, sleet, and/or rain) or fog. In normal conditions where precipitation or fog is not present, the apertures must be periodically cleaned to remove dirt, insect debris, and similar contaminants that can degrade sensor operation. Aperture cleaning can include sensor cleaning fluid and/or compressed air. The sensor cleaning fluid and air are heated during low-temperature operations to improve their ability to remove frozen material. In adverse weather conditions, these apertures must be kept free of precipitation (e.g., snow, sleet, and/or rain) or fog, which may result in additional use of sensor cleaning fluid and/or compressed air, requiring incremental increase in energy to pump, heat, cool, etc. the sensor cleaning fluid and/or compressed air.

In addition to sensor aperture cleaning, the tiara provides cooling and heating for the sensors 115 to maintain a temperature of the sensors 115 within a specified range of a target temperature T_{sensor_tgt}. The specified range may be, for example, the target temperature T_{sensor_tgt}+/−0.5° C.

The computer 110 can be programmed to estimate the energy requirements E_{sensor_cleaning} to mitigate the effects of weather on the sensors 115 based on weather data and vehicle specifications. For example, the computer 110 may be programmed to receive weather data indicating a likely amount of precipitation on an hourly basis for a location on a selected day. The computer 110 can be programmed to request and receive this weather data, for example from the server 145.

Vehicle specifications obtained or created during the design of the vehicle 105 can specify an amount of power required to cool or heat the sensors 115 and clean the sensor apertures. FIGS. 10 and 11 are example graphs illustrating vehicle specifications that can be applied to determining the energy requirements to mitigate the effects of weather on sensors 115.

FIG. 8 is an example graph specifying an amount of heating and cooling required to maintain sensors 115 within a specified range of a target temperature, T_{sensor_tgt}, across a range of ambient temperatures T_{ambient}. As an example, the target temperature T_{sensor_tgt} for the sensors may be 18° C., and the specified range may be 18° C.+/−0.5° C. Example curve 802 specifies an amount of energy required to cool the sensors 115 for ambient temperatures T_{ambient} above the target temperature T_{sensor_tgt}. Example curve 804 specifies an amount of energy required to heat the sensors 115 for ambient temperatures T_{ambient} below the target temperature T_{sensor_tgt}.

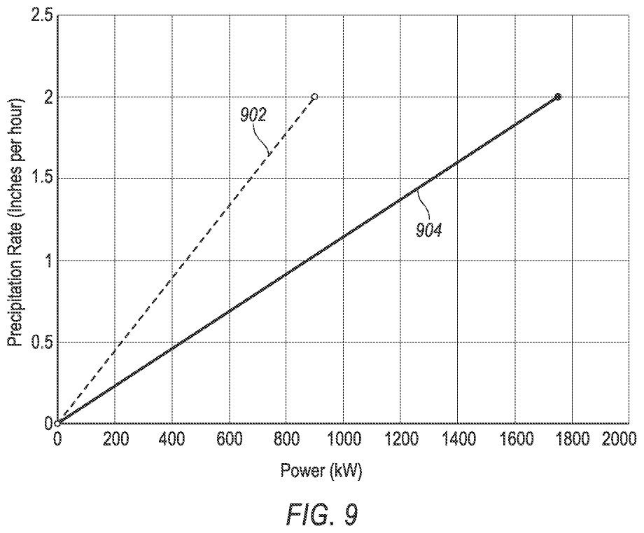

FIG. 9 is an example graph specifying an amount of energy for heating and cooling requirements for mitigating the effects of precipitation for a range of precipitation rates, R_{precip}. Example curve 902 specifies an amount of power required for mitigating the effects of rain and example curve 904 specifies an amount of power required for mitigating the effects of snow.

The computer 110 can be programmed to receive weather data indicating ambient temperature T_{ambient} and the precipitation rate R_{precip} for an environment in which the vehicle 105 is operating. The computer 110 may also receive (or maintain in a storage) vehicle 105 specifications that specifies the amount of energy required to mitigate the effects of weather, including ambient temperature T_{ambient} and rates of precipitation R_{precip}, such as the data illustrated in FIGS. 8 and 9. Based on the weather data, the computer 110 can further be programmed to determine from the vehicle 105 specifications, an estimated amount of energy required to mitigate the effects of weather on the sensors 115.

In addition to heating and cooling of the sensors 115, the vehicle 105 deploys sensor maintenance components 130 to clean the sensors 115 to remove dirt, insect debris, and similar contaminants that can degrade sensor operation. Aperture cleaning can include sensor cleaning fluid and/or compressed air. The sensor cleaning fluid and air are heated during low-temperature operations to improve their ability to remove frozen material. In adverse weather conditions, these apertures must be kept free of precipitation (e.g., snow, sleet, and/or rain) or fog, requiring incremental increase in energy to pump, heat, cool, etc. the sensor cleaning fluid and/or compressed air. The computer 110, based on vehicle models and weather data, may determine a rate of energy usage for cleaning sensors, P_{sensor_clean} which can be included in estimations for E_{sensor_maint}.

As an example, the computer 110 may be programmed estimate the energy requirements E_{sensor_maint} to mitigate the effects of weather on sensors 115 based on weather data and vehicle specifications according to equation 7, below:

E_{sensor_maint}(Tₘᵢₛₛᵢₒₙ,T_{precip},R_{precip},T_{sensor_tgt},T_{ambient})=P_{sensor_temp_maint}(T_{ambient},T_{sensor_tgt})×Tₘᵢₛₛᵢₒₙ+P_{precip_clean}(R_{precip})×T_{precip}+P_{sensor_clean}(T_{ambient},R_{precip})×(Tₘᵢₛₛᵢₒₙ) Eq. 7

where:
E_{sensor_maint}=the total energy required for sensor cleaning on the mission (Joules)
P_{sensor_temp_maint}=the continuous power required to maintain the sensors at the target temperature (watts).

Tₘᵢₛₛᵢₒₙ=mission duration (seconds).
P_{precip_clean} (R_{precip})=continuous power required to clean the tiara sensors in the presence of the precipitation rate (watts).
R_{precip}=the precipitation rate (inches per hour).
T_{precip}=duration of the precipitation during the mission (seconds).
P_{sensor_clean}=the power required to operate sensor cleaning mechanisms (watts).

The computer 110 can further be programmed to estimate the energy required to heat and cool vehicle control modules E_{module} based on expected weather conditions. When the vehicle 105 is started, for example, the control modules must be cooled or heated to bring then within a specified temperature range. The specified temperature range be a target temperature T_{mod_tgt}+/−a tolerance. The target temperature T_{mod_tgt} may be, for example, 23° C. and the tolerance may be 0.5° C. After bringing the modules to within the specified temperature range, the computer 110 can be further programmed to maintain the modules within the specified temperature range.

The computer 110 may, for example, estimate the estimate the energy required to heat and cool vehicle control modules E_{module} according to equation 8 below:

E_{module}(T_{mod_tgt},T_{ambient})=E_{PUPD_mod}(T_{mod_tgt}−T_{ambient})+P_{ss_mod}(T_{mod_tgt}−T_{ambient})×Tₘᵢₛₛᵢₒₙ Eq. 8

where:
E_{module}=the energy to maintain module temperature within a specified range.
E_{PUPD_mod}=the energy to pull up or pull down the modules to the specified temperature range.
P_{ss_mod}=the energy required to maintain the modules within the specified temperature range.
T_{mod_tgt}=the target temperature for the module.

The computer 110 can be programmed to receive weather data and vehicle data as described above. The vehicle data may include the amount of energy required to pull up or pull down a module to within a specified temperature range and the amount of energy required to maintain the module within the specified range based on ambient temperature.

The computer 110 can further be programmed to estimate the energy required to heat and cool the vehicle high-voltage traction battery 135 E_{HV} based on expected weather conditions. When the vehicle 105 is started, for example, the high voltage traction battery 135 must be cooled or heated to bring it within a specified temperature range. The specified temperature range be a target temperature T_{HV_tgt}+/−a tolerance. The target temperature T_{HV_tgt} may be, for example, 23° C. and the tolerance may be 0.5° C. After bringing the high-voltage traction battery 135 to within the specified temperature range, the computer 110 can be further programmed to maintain the high-voltage traction module within the specified temperature range.

The computer 110 may, for example, estimate the estimate the energy required to heat and cool vehicle control modules E_{module} according to equation 8 below:

E_{HV}(T_{HV_tgt},T_{ambient})=E_{PUPD_HV}(T_{HV_tgt}−T_{ambient})+P_{ss_HV}(T_{HV_tgt}−T_{ambient})×Tₘᵢₛₛᵢₒₙ Eq. 9

where:
E_{HV}=the energy to maintain HV traction battery 135 temperature within a specified range.
E_{PUPD_HV}=the energy to pull up or pull down the HV traction battery 135 to the specified temperature range.
P_{SS_HV}=the energy required to maintain the HV traction battery 135 within the specified temperature range.
T_{HV_tgt}=the target temperature for the HV traction battery.

The computer 110 can be programmed to receive weather data and vehicle data as described above. The vehicle data may include the amount of energy required to pull up or pull down the high voltage traction battery 135 to within a specified temperature range and the amount of energy required to maintain the high-voltage traction battery 135 to within the specified range based on ambient temperature.

Based on equations 5, 6, 7, 8 and 9 above, the computer 110 can calculate the estimated weather-related energy usage E_{weather} to mitigate the effects of weather on the mission. The computer 110 can further be programmed to determine a portion of the estimated energy E_{weather} for each segment along the route. For example, during an initial period of the mission, the vehicle 105 may consume energy at a first rate to bring a cabin temperature, sensor temperatures, module temperatures, and high-voltage traction battery 135 to target levels. Based on vehicle specifications, the computer 110 may determine a rate of energy usage (power) related to weather to perform these functions. The computer 110 can then multiply the rate of energy usage times a time-on-segment (t_{on-segment}) to determine the energy usage during the segment. For segments during which the cabin temperature, sensor 115 temperatures, module temperatures, and high-voltage traction battery 135 are expected to be at target levels, the computer 110 can calculate the rate of energy usage based on the energy requirements to maintain the temperatures within respective specified temperature ranges. In this manner, the computer 110 can estimate the energy usage for the vehicle 105 at the indexed segment.

The process 300 continues in a block 335. In the block 335, the computer 110 is programmed to calculate a total route segment energy E_{segment}. The total route segment energy E_{segment} is the total energy, e.g., measured in joules, that the vehicle 105 will use on the indexed route segment and can be calculated as a sum of the expected base load energy usage E_{baseload}, the expected motive energy usage Eₘₒₜᵢᵥₑ, the expected time-of-day energy E_{TOD}, and the expected weather-related energy usage E_{weather} as described above.

E_{segment}=E_{baseload}+Eₘₒₜᵢᵥₑ+E_{TOD}+E_{weather} Eq. 10

Next, in a block 340, the computer 110 is programmed to determine whether the current value of the segment index is equal to the total number of segments remaining in the mission. In the case that segment index value is equal to the total number of segments in the mission, the process 300 continues in a block 350. Otherwise, the process 300 continues in a block 345.

In the block 345, the computer 110 is programmed to increment the value of index. That is: index value=index value+1. The process 300 continues in the block 310 to evaluate energy usage in the next segment of the route segment table.

In the block 350, which may follow the block 340, the computer 110 is programmed to determine an expected vehicle energy usage for the remainder of the mission. The computer 110 calculates the sum of the segment energy E_{segment} for each remaining segment in the mission to determine the estimated energy usage for the remainder of the mission. The process 300, which may have been invoked by block 225 of process 200, ends. Process 200 can continue in the block 230.

### CONCLUSION

Computing devices as discussed herein generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computing device is generally a collection of data stored on a computer readable medium, such as a storage medium, a random-access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random-access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH, an EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

What is claimed is:

1. A system comprising:
a computer including a processor, and a memory storing instructions executable by the processor to:
select a route for a vehicle based on an expected vehicle energy usage along the route based on an expected condition along the route in an environment above a road; and
operate the vehicle along the route.

2. The system of claim 1, wherein the expected condition is an expected weather condition.

3. The system of claim 2, wherein the expected weather condition includes at least one selected from a group of ambient temperature, precipitation and fog.

4. The system of claim 1, the instructions further including instructions to estimate the expected vehicle energy usage according to the expected condition by accounting for an expected energy usage for sensor maintenance along the route under the expected condition.

5. The system of claim 4, wherein the expected energy usage for sensor maintenance includes an expected energy usage to maintain a temperature of a sensor within a specified range.

6. The system of claim 4, wherein the expected energy usage for sensor maintenance includes an expected energy usage to clean a sensor.

7. The system of claim 1, the instructions further including instructions to estimate the expected vehicle energy usage according to the expected condition based on an expected energy usage to maintain a temperature of an electronic control module within a specified range.

8. The system of claim 1, the instructions including instructions to estimate the expected vehicle energy usage based on an expected energy usage to maintain a temperature of a high-voltage traction battery within a specified range.

9. The system of claim 1, the instructions further including instructions to:
update the expected condition while operating the vehicle along the route;
adjust an operating parameter of the vehicle based on the updated expected condition; and
update the expected energy usage based on adjusting the operation of the vehicle.

10. The system of claim 9, wherein the instructions to adjust the operating parameter of the vehicle include instructions to adjust a speed of the vehicle.

11. The system of claim 1, wherein the instructions to select the route include instructions to take into account an availability of sensor cleaning fluid.

12. The system of claim 1, wherein the expected vehicle energy usage includes an expected energy usage of a high-voltage traction battery.

13. A method comprising:
selecting a route for a vehicle based on an expected vehicle energy usage along the route based on an expected condition along the route in an environment above a road; and
operating the vehicle along the route.

14. The method of claim 13, wherein the expected condition is an expected weather condition.

15. The method of claim 13, further comprising:
estimating the expected vehicle energy usage according to the expected condition by accounting for an expected energy usage for sensor maintenance along the route under the expected condition.

16. The method of claim 15, wherein the expected energy usage for sensor maintenance includes at least one selected from a group of an expected energy usage to maintain a temperature of a sensor within a specified range and an expected energy usage to clean a sensor.

17. The method of claim 13, further comprising:
estimating the expected vehicle energy usage according to the expected condition based on at least one selected from a group of an expected energy usage to maintain a temperature of an electronic control module within a specified range and an expected energy usage to maintain a temperature of a high-voltage traction battery within a specified range.

18. The method of claim 13, further comprising:
updating the expected condition while operating the vehicle along the route;
adjusting an operating parameter of the vehicle based on the updated expected condition; and
updating the expected energy usage based on adjusting the operation of the vehicle.

19. The method of claim 13, wherein selecting the route includes taking into account an availability of sensor cleaning fluid.

20. The method of claim 13, wherein the expected vehicle energy usage is an expected energy usage of the high-voltage traction battery.
